(19) United States
(12) Patent Application Publication
(10) Pub. No.: US 2025/0196146 A1
(43) Pub. Date: Jun. 19, 2025

(54) LABELING TECHNIQUE USING LASER-MARKABLE INK

(71) Applicant: New Erie Scientific LLC, Portsmouth, NH (US)

(72) Inventors: Robinson Anandakathir, Westford, MA (US); Philip Kyd, Portsmouth, NH (US)

(21) Appl. No.: 18/543,535

(22) Filed: Dec. 18, 2023

(51) Int. Cl. B01L 3/00; C09D 11/037

(52) U.S. Cl. CPC B01L 3/54; C09D 11/037

(57) ABSTRACT

Systems, methods, and devices for providing a labeling technique for microscope slides using laser-markable ink are described. In some embodiments, laser-markable ink may be applied to a microscope slide or a sheet comprising a plurality of microscope slides. A laser may be provided to a portion of the laser-markable ink to initiate a chemical reaction in the laser-markable ink. The chemical reaction may mark a surface of the microscope slide at the portion of the laser-markable ink. The surface of the microscope slide may be marked with information and/or machine-readable indicia without etching the surface of the microscope slide.

### BACKGROUND

### 1. Field

Embodiments of the present disclosure generally relate to labeling microscope slides. More specifically, embodiments of the present disclosure relate to marking microscope slides with markable ink.

### 2. Related Art

Previous techniques for labeling microscope slides involve writing labels by hand either directly on the microscope slide or on a tab on the surface of the microscope slide. Handwriting techniques are time-consuming and lack ample data density of the label. Humans are limited to the amount of data that can be compressed into a specified area, such as on a microscope slide. Alternative techniques for labeling microscope slides include ink jet printing, thermal transfer printing, and etching on the surface of the microscope slides or through an ink layer on the surface of the microscope slides by utilizing a scribe, rotating bit, or laser. These etching techniques each have limitations. For example, these etching techniques have ample data density but create a label that easily loses data and creates airborne particulates during the etching process. Additionally, etched labels can be hard to read by human eyes due to the rough edges of the labels. Accordingly, labeling techniques for microscope slides create labels that lack ample data density, reliability, and readability.

### SUMMARY

Embodiments of the present disclosure solve the above-mentioned problems by providing a system, method, and device for labeling a microscope slide using laser-markable ink. In particular, laser-markable ink is ink that undergoes a chemical reaction (causing, for example, a color change) when exposed to a laser beam, thus allowing slides to be automatically labeled by a laser system without the disadvantages of etching the glass of the slides directly. These automatically generated labels can be human-readable, machine-readable, or both.

In some aspects, the techniques described herein relate to a method for labeling a microscope slide, the method including: applying laser-markable ink to at least a portion of the microscope slide; and exposing a patterned portion of the laser-markable ink on the microscope slide to a laser beam, thereby initiating a chemical reaction in the laser-markable ink to cause a change in color in the patterned portion of the laser-markable ink without etching a surface of the microscope slide.

In some aspects, the techniques described herein relate to a method, further including: selecting a value for a parameter for the laser beam, wherein the parameter is selected from a set consisting of a wavelength, an energy density, a laser speed, a power, a frequency, a pulse length, a spot size, and a spot shape.

In some aspects, the techniques described herein relate to a method, wherein the laser-markable ink is applied in a thickness range of 5 micrometers to 200 micrometers.

In some aspects, the techniques described herein relate to a method, wherein the chemical reaction includes a carbonization of the laser-markable ink.

In some aspects, the techniques described herein relate to a method, wherein the laser-markable ink includes a dye or a pigmented ink, a polymer additive, an inorganic material, and a solvent.

In some aspects, the techniques described herein relate to a method, wherein the portion of the microscope slide is selected from a set consisting of a tab, a label, and a pattern.

In some aspects, the techniques described herein relate to a method, wherein the patterned portion of the laser-markable ink is selected from a set consisting of a quick response code, a one-dimensional barcode, a two-dimensional barcode, and a text label.

In some aspects, the techniques described herein relate to a method for manufacturing a plurality of labeled microscope slides, the method including: providing a sheet of slide material including a laser-markable ink on at least a portion of the sheet of the slide material; and exposing a patterned portion of the laser-markable ink on the sheet of the slide material to a laser beam, thereby initiating a chemical reaction in the laser-markable ink to cause a change in color in the patterned portion of the laser-markable ink without etching a surface of the sheet of the slide material; and separating the sheet of the slide material into the plurality of labeled microscope slides.

In some aspects, the techniques described herein relate to a method, wherein the laser-markable ink is applied in a thickness range of 5 micrometers to 200 micrometers.

In some aspects, the techniques described herein relate to a method, wherein the laser-markable ink is a first laser-markable ink of a first color, further including: applying a second laser-markable ink of a second color to at least another portion of the sheet of the slide material.

In some aspects, the techniques described herein relate to a method, selecting a value for a parameter for the laser beam, wherein the parameter is selected from a set consisting of a wavelength, an energy density, a laser speed, a power, a frequency, a pulse length, a spot size, and spot shape.

In some aspects, the techniques described herein relate to a method, wherein the chemical reaction includes a carbonization reaction.

In some aspects, the techniques described herein relate to a method, wherein the chemical reaction changes a brightness of the color of the patterned portion of the laser-markable ink and wherein the patterned portion is selected from a set consisting of a quick response code, a one-dimensional barcode, a two-dimensional barcode, and a marked label.

In some aspects, the techniques described herein relate to a method, further including heating the laser-markable ink prior to exposing the laser-markable ink to the laser beam.

In some aspects, the techniques described herein relate to a method for manufacturing labeled microscope slides, the method including: providing a sheet of slide material including a laser-markable ink on the sheet of the slide material; separating the sheet of the slide material into a plurality of slides, wherein the laser-markable ink covers a portion of each of the plurality of slides; and exposing a patterned portion of the laser-markable ink on a microscope slide of the plurality of slides to a laser beam, thereby initiating a chemical reaction in the laser-markable ink to cause a change in color in the patterned portion without etching a surface of the microscope slide.

In some aspects, the techniques described herein relate to a method, wherein the sheet of the slide material includes one or more inks on at least another portion of the sheet of the slide material.

In some aspects, the techniques described herein relate to a method, wherein the sheet of the slide material includes a coating on the sheet of the slide material.

In some aspects, the techniques described herein relate to a method, wherein the chemical reaction includes carbonization of an organic component of the laser-markable ink.

In some aspects, the techniques described herein relate to a method, wherein the chemical reaction changes a brightness of the color of the laser-markable ink to create a marked portion corresponding to the patterned portion.

In some aspects, the techniques described herein relate to a method, wherein the marked portion is selected from a set consisting of a quick response code, a one-dimensional barcode, a two-dimensional barcode, and a marked label.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE DRAWINGS

Embodiments of the present disclosure are described in detail below with reference to the attached drawing figures, wherein:

FIG. 1 depicts an exemplary laser system for marking microscope slides;

FIG. 2 depicts an exemplary inked sheet;

FIG. 3 depicts an exemplary inked microscope slide;

FIG. 4 depicts an exemplary laser marking process;

FIG. 5 depicts an exemplary plurality of labeled microscope slides;

FIG. 6 depicts an exemplary method for manufacturing laser-markable ink;

FIG. 7A depicts an exemplary method for applying a layer of laser-markable ink to a sheet;

FIG. 7B depicts an exemplary method for providing a laser marking process to a sheet with a layer of laser-markable ink;

FIG. 7C depicts an exemplary method for creating a plurality of labeled microscope slides from an inked sheet; and

FIG. 8 depicts one example of a hardware platform representative of an embodiment of a hardware system.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION

The following detailed description of embodiments of the present disclosure references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized, and changes can be made without departing from the scope of the present disclosure. Therefore, the following detailed description is not to be taken in a limiting sense. The scope of embodiments of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments but is not necessarily included. Thus, the technology can include a variety of combinations and/or integrations of the embodiments described herein.

There exists a need for labeling techniques for microscope slides that create labels that have high information density, are reliable, and are readable. Labeling microscope slides with laser-markable ink by the systems and methods described herein create labels that have high information density, are reliable, are readable, and are durable. In some embodiments, marking the laser-markable ink with a laser allows for high-density information storage, including encoded information (e.g., a quick response (QR) code and/or a bar code). Further, in some embodiments, laser-markable ink allows for the creation of markings without substantially etching the glass surface of the slide or etching the ink through to the glass such that the labels created with laser-markable ink are reliable, readable, and durable. Further details of microscope sheet marking by laser marking laser-markable ink may be found in commonly owned PCT Application Serial No. [Docket No. 2971-3.00], titled “REVERSE MARKING OF MICROSCOPE SLIDES” the entirety of which is incorporated by reference herein. All, or some of the embodiments described herein may be performed by an ink manufacturer for producing slides for an end user. Similarly, or alternatively, laser-markable ink 26, laser parameters, and process descriptions, as described herein may be provided to the end user (e.g., a lab, a hospital, an education institution, a pharmaceutical company, or the like), and the end user may perform all or some of the processes described herein. As such, any combination of processes may be performed by a manufacturer and/or the end user.

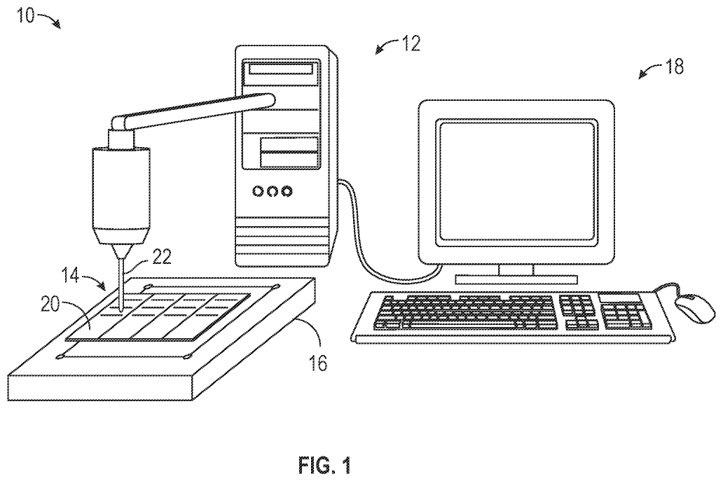

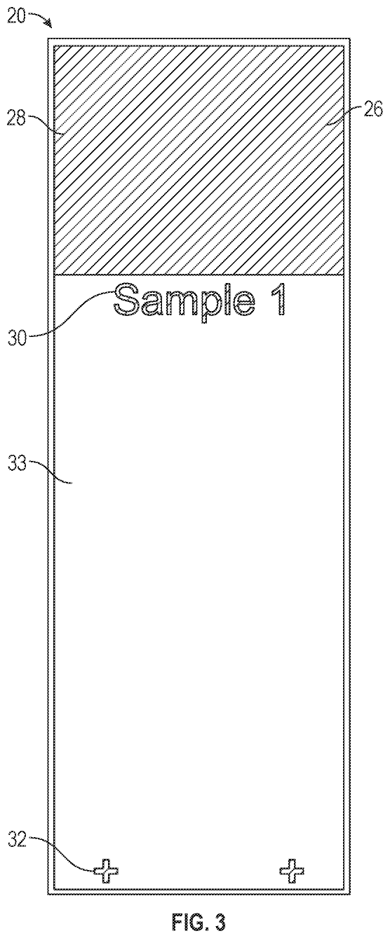

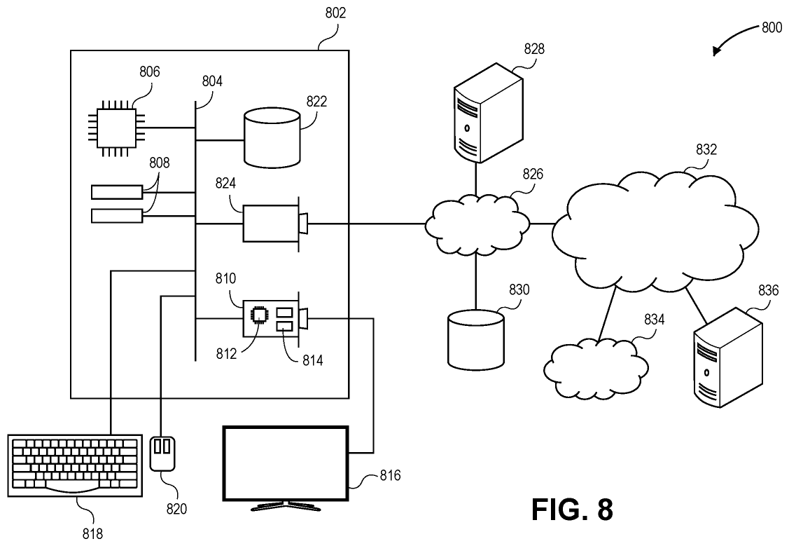

FIG. 1 depicts an embodiment of laser system 10 for marking inked microscope slide 20 (FIG. 3) of microscope sheet 14. In some embodiments, laser marking system 10 comprises computer 18 communicatively coupled to laser generating system 12 configured to generate and control laser 22 to mark inked microscope slide 20. In some embodiments, computer 18 and laser generating system 12 each comprise hardware system 800 (FIG. 8). A user may provide input to computer 18, the input comprising information to be displayed by the slide. The information may be stored and accessible for generating coordinates for laser generating system 12 to mark sheet 14 as described below.

In some embodiments, laser marking system 10 may be manual such that a user controls the operation of laser 22 and the movement of laser 22 and/or the movement of sheet 14 to generate the mark on inked microscope slide 20. In some embodiments, laser marking system 10 may be fully automated such that the operation and/or movement of laser 22 and/or movement of inked microscope slide 20 is automated to label inked microscope slide 20. In some embodiments, laser marking system 10 may comprise one or more non-transitory computer-readable media storing computer-executable instructions that, when executed by at least one processor, perform methods of labeling inked microscope slide 20 described herein. Embodiments are contemplated in which a plurality of lasers may be utilized to mark the layer on sheet 14 such that multiple portions of the layer of laser-markable ink 26 on sheet 14 are being marked simultaneously.

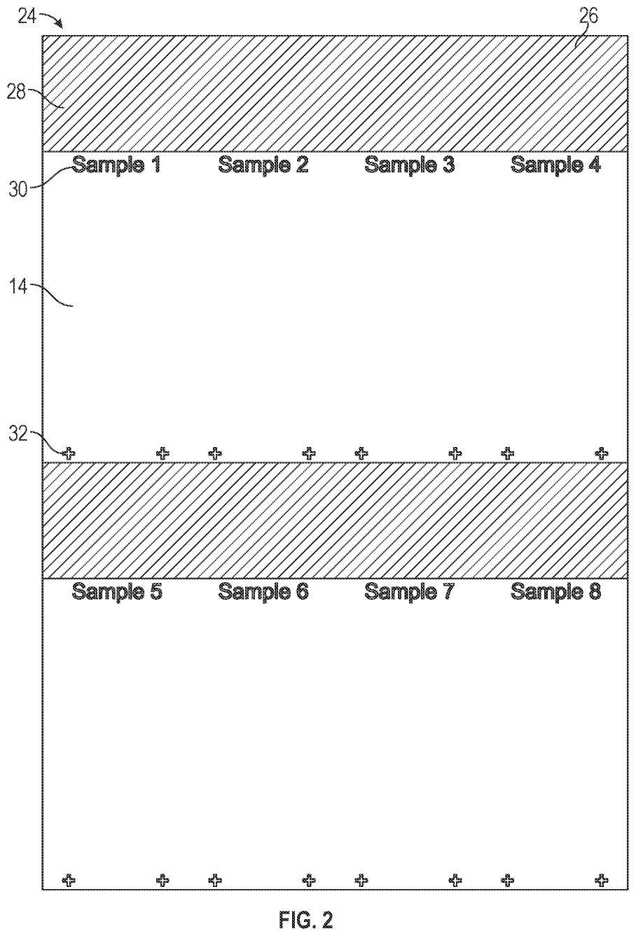

In some embodiments, inked microscope slide 20 may be positioned on platform 16 below laser 22. Inked microscope slide 20 may be positioned on platform 16 by the user or may be positioned by a machine automatically. In some embodiments, prior to placement on platform 16, laser-markable ink 26 (FIG. 2) may be disposed on slide 20. Laser-markable ink 26 may be disposed on a slide to create inked microscope slide 20 by various methods described herein.

In some embodiments, sheet 14 may be placed on platform 16 and marked in an automated process, a manual process, or a combination of a manual process and an automated process. In some embodiments, the automated process may comprise automatically retrieving, tabbing, marking, and packaging sheet 14. Similarly, a plurality of sheets may be retrieved, tabbed, marked, and packaged. As such, sheet 14, in some embodiments, sheet 14 may represent at least one slide, one or more slides, and/or a plurality of slides. For example, sheet 14 may comprise a plurality of slides or a single slide (e.g., slide 20). As such, the processes described herein may apply to sheet 14 comprising a plurality of slides or sheet 14 comprising a single slide (e.g., inked slide 20 or slide 33). Some descriptions herein reference slide 20, but it should be understood that slide 20 may be simply sheet 14 comprising a single slide rather than a plurality of slides or a plurality of slides comprising slide 20. Similarly, some descriptions herein reference slide 33, but it should be understood that slide 33 may be simply sheet 14 comprising a single slide rather than a plurality of slides or a plurality of slides comprising slide 33.

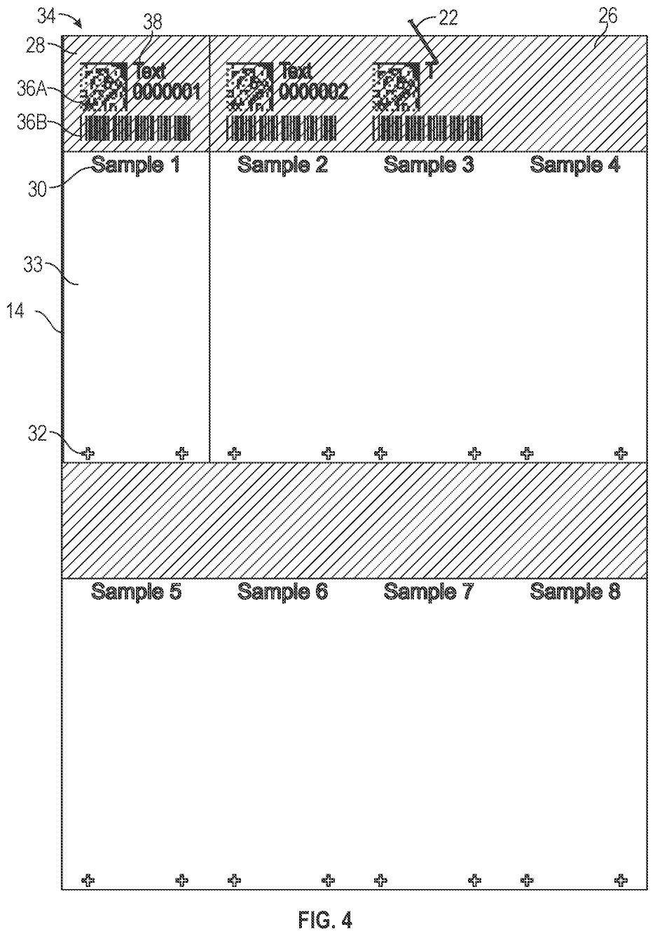

In some embodiments, at least one parameter may be selected for laser marking process 34 (FIG. 4) prior to providing laser marking process 34. In some embodiments, the at least one parameter comprises any combination of laser parameters such as wavelength, energy density, laser marking speed, power, frequency, pulse length, spot size, and spot shape, as well as any other suitable parameter and combination of constituents thereof. In some embodiments, the wavelength of laser 22 may be within a range of 157 nanometers (nm) to 10,600 nm. Further, in some embodiments, the wavelength of laser 22 may be within a range of 500 nm to 5,000 nm. For example, laser 22 may comprise a wavelength of 1064 nm. Furthermore, the wavelength of laser 22 may be in the ultraviolet (UV) range of 300 nm to 400 nm. Broadly, any suitable wavelength range is contemplated for use with the invention, as are multiple wavelengths of laser. In some embodiments, the energy density of laser 22 may be within a range of 0.3 millijoules per square centimeter (mJ/cm²) to 50 mJ/cm². In some embodiments, the laser marking speed of laser 22 may be within a range of 100 millimeters per second (mm/s) to 2,000 mm/s. Further, in some embodiments, the laser marking speed of laser 22 may be within a range of 600 mm/s to 1200 mm/s. For example, the laser marking speed of laser 22 may be 1,000 mm/s.

In some embodiments, the operational power of laser 22 may be within a range of 5% to 100% of the total power of laser 22. Further, in some embodiments, the operational power of laser 22 may be within a range of 50% to 100% of the total power of laser 22. Embodiments are contemplated in which the total power of laser 22 may be within a range of 1 watt (W) to 1,000 W. For example, the total power of laser 22 may be 2.5 W.

In some embodiments, the pulse frequency of laser 22 may be within a range of 5 kilohertz (kHz) to 500 kHz. For example, the pulse frequency of laser 22 may be 300 kHz. Further, in some embodiments, the pulse frequency of laser 22 may be within a range of 50 kHz to 200 kHz. In some embodiments, the pulse length of laser 22 may be within the range of 5 μs to 50 μs. Further, in some embodiments, the pulse length of laser 22 may be within the range of 10 microseconds (μs) to 25 μs. For example, the pulse length of laser 22 may be 20 μs.

In some embodiments, the selected parameters depend at least in part on the type of laser used for laser marking process 34. In some embodiments, the selected parameters depend on the characteristics of a layer of laser-markable ink 26 (FIG. 2) as described below. Further, in some embodiments, the selected parameters depend, at least in part, on any combination of chemical properties, physical properties, and composition of laser-markable ink 26. For example, in some embodiments, laser 22 may utilize non-visible laser parameters (e.g., wavelength 1064 nm, maximum power output 3 W, minimum pulse energy 0.1 mJ, and pulse duration 3 nanoseconds), and visible laser parameters (e.g., wavelength 640 nm and maximum output power of 5 milliwatts). The parameters of laser 22 described herein are intended to be exemplary only and may be modified to optimize marking of laser-markable ink 26 on sheet 14.

FIG. 2 depicts an exemplary inked sheet 24, which, in some embodiments, may be sheet 14 depicted in FIG. 1. In some embodiments, inked sheet 24 may be manufactured by providing a glass or plastic sheet 14 and applying a layer of laser-markable ink 26 to at least a portion of the surface of sheet 14. Embodiments are contemplated in which sheet 14 may comprise any material suitable for manufacturing the microscope slides described herein. For example, sheet 14 may be composed of plastic, glass, float glass, drawn glass, quartz, silica glass, acrylic glass, tempered glass, and/or any other material that may receive the marking as described herein and may be suitable for receiving samples (for example, medical samples) as described herein. In some embodiments, the processes to create the layer of laser-markable ink 26 comprise any combination of screen printing, rotary screen printing, ink-jet printing, digital printing, offset printing, pad printing, gravure printing, rotogravure printing, lithograph printing, surface printing, flexographic printing, stamping, painting, drawing, sketching, and spraying, as well as any other suitable applying process and constituents thereof.

In some embodiments, the layer of laser-markable ink 26 may be applied to sheet 14 with consideration of where sheet 14 may be separated to manufacture the plurality of microscope slides. For example, the layer of laser-markable ink 26 may be applied such that when sheet 14 is separated, the layer of laser-markable ink 26 on each microscope slide may be similar.

In some embodiments, the layer of laser-markable ink 26 may comprise any combination of an inked tab 28, an inked label 30, and an inked pattern 32, as well as any other suitable configuration of an ink layer and constituents thereof. In some embodiments, inked tab 28 covers at least one edge of sheet 14. Further, in some embodiments, inked tab 28 extends from at least one edge of sheet 14 such that when sheet 14 is processed to manufacture a plurality of microscope slides (e.g., microscope slide 33), each microscope slide comprises a tab that can be held without smudging, dirtying, and/or disrupting the surface of each microscope slide without the layer of laser-markable ink 26. Embodiments are contemplated in which inked tab 28 may not cover an edge of sheet 14, but when processed to manufacture the plurality of microscope slides, inked tab 28 may cover at least one edge of each microscope slide.

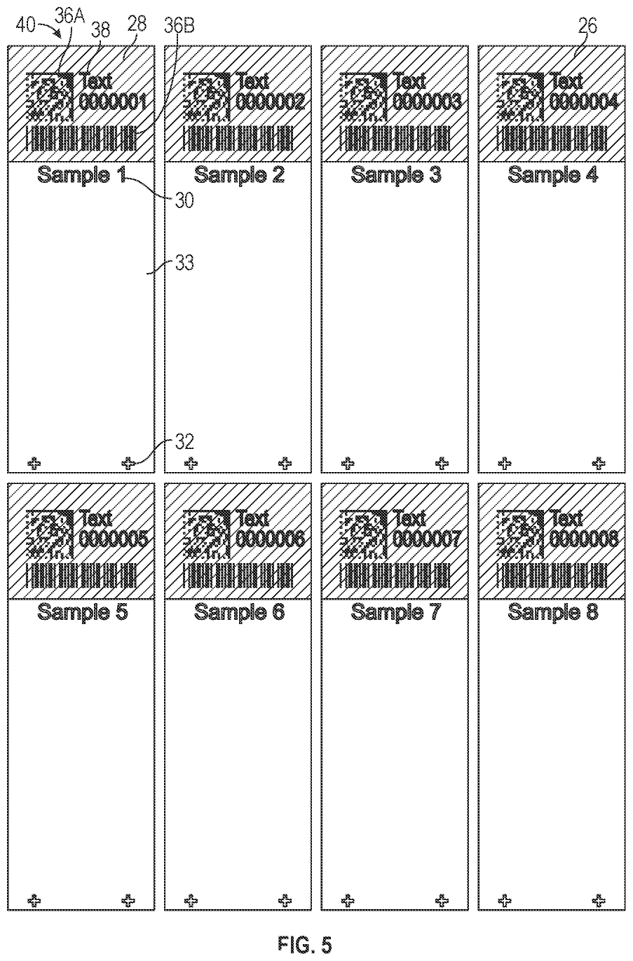

In some embodiments, inked label 30 comprises any combination of text, characters, and numerals, as well as any other suitable labels and constituents thereof. For example, as depicted in FIG. 2, inked label 30 may comprise a combination of characters and numerals such that when sheet 14 is processed to manufacture a plurality of microscope slides, each microscope slide may be distinguishable from other inked microscope slides (e.g., inked microscope slide 20). In another example, inked label 30 may comprise a company name and/or logo such that a plurality of identical inked microscope slides may be manufactured after processing sheet 14. In some embodiments, the inked pattern 32 comprises any combination of text, shapes, forms, bodies, patterns, fills, frames, and borders, as well as any other suitable symbols and constituents thereof. For example, inked pattern 32 may comprise a border around the edge of one or more microscope slides from the plurality of microscope slides that may be manufactured by sheet 14 (discussed below and illustrated in FIG. 5) to indicate the usable space of one or more microscope slides. Alternatively, or additionally, for example, the inked pattern 32 may comprise one or more cross shapes for indicating a suggested usable space of one or more microscope slides from the plurality of microscope slides that may be manufactured by sheet 14. Embodiments are contemplated in which inked pattern 32 comprises a shape to distinguish the utilization of one or more microscope slides from the plurality of microscope slides that may be manufactured by sheet 14. For example, inked microscope slide 20 with inked pattern 32 comprising a circle shape may be utilized for different purposes than inked microscope slide 20 with inked pattern 32 comprising a square shape.

In some embodiments, the layer of laser-markable ink 26 may cover a predetermined percentage of the surface area of sheet 14 such that the layer may comprise ample surface area to be marked using the laser marking process 34 described in FIG. 4. In some embodiments, the layer covers 5% to 50% of the surface area of sheet 14. However, using the methods described herein, laser markable ink 26 may cover any amount of the surface area of sheet 14 as described below. Embodiments are contemplated in which the layer of laser-markable ink 26 may cover a predetermined percentage of the surface area of one or more microscope slides from the plurality of microscope slides that may be manufactured by sheet 14. In such embodiments, the predetermined percentage for one or more microscope slides may be within a range of 5% to 50% of the surface of each microscope slide.

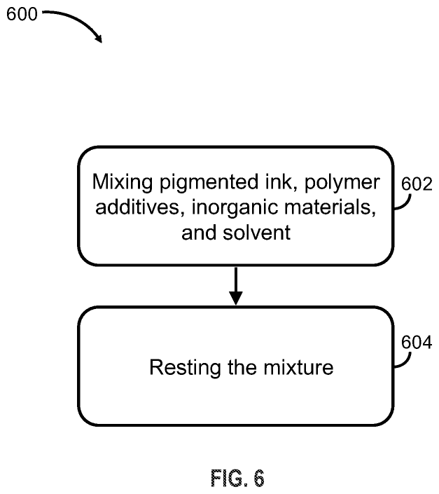

In some embodiments, the thickness of the layer of laser-markable ink 26 may be within a range of 5 micrometers (μm) to 200 μm. In some embodiments, the thickness of the layer of laser-markable ink 26 may be within a range of 5 μm to 100 μm. Further, in some embodiments, the thickness of the layer may be within a range of 15 μm to 35 μm. The thickness of the layer of laser-markable ink 26 may depend at least in part on a laser marking process (discussed later in FIG. 4). For example, the thickness of the layer of laser-markable ink 26 may be greater than 12 μm such that the layer may be reactive to laser radiation. Embodiments are contemplated in which the thickness of the layer may depend at least in part on any combination of chemical properties, physical properties, and composition of laser-markable ink 26 (discussed later in FIG. 6). For example, a more viscous formulation of laser-markable ink 26 may result in a thickness within the range of 5 μm to 20 μm. Embodiments are also contemplated in which the thickness of the layer may depend at least in part on the process utilized for applying laser-markable ink 26 to sheet 14. For example, a screen-printing process may provide a layer of laser-markable ink 26 with a thickness within the range of 15 μm to 35 μm. Further, for example, hand-applying a layer of laser-markable ink 26 to sheet 14 may result in a thickness within the range of 50 μm to 80 μm. Various layer thicknesses may generate different markings on sheet 14 and may be selected for different purposes, as described herein.

In some embodiments, more than one layer of laser-markable ink 26 may be applied to sheet 14 as described above. For example, a first layer of laser-markable ink 26 comprising a first color may be provided on a portion of the surface of sheet 14 and a second layer of laser-markable ink 26 comprising a second color may be provided on a portion of the surface of sheet 14. In some embodiments, a portion covered by a first layer of laser-markable ink 26, and a portion covered by a second layer of laser-markable ink 26 may at least partially overlap. Alternatively, in some embodiments, a first portion covered by a first layer of laser-markable ink 26, and a second portion covered by a second layer of laser-markable ink 26 may be disjoint locations such that the first layer and the second layer do not overlap. In some embodiments, one or more layers of laser-markable ink 26 may be sequentially or concurrently applied to sheet 14. For example, in a screen-printing process, a first layer of laser-markable ink 26 comprising a first color and a second layer of laser-markable ink 26 comprising a second color may be applied sequentially using a conveyor belt system incorporated into an ink application process.

In some embodiments, the layer of laser-markable ink 26 may comprise any combination of white, black, blue, green, red, cyan, magenta, and yellow, as well as any other suitable color and constituents thereof. Further, in some embodiments, the color of the layer of laser-markable ink 26 may be used as an identifier for one or more microscope slides from the plurality of microscope slides that may be manufactured by sheet 14. For example, a microscope slide with a red layer of laser-markable ink 26 may be utilized to identify that the microscope slide may undergo a chemical bath by an end user and may require protective gear to handle the microscope slide safely. In some applications, a variety of color options may be provided, and end users may assign significance (for example, a specific workflow) to different colors. In some embodiments where ink is applied to a sheet of slides, the individual slides may be separated once the ink has been applied. Alternatively, the sheets may be shored, perforated, or otherwise marked for separation by an end user.

FIG. 3 depicts an exemplary inked microscope slide 20. In some embodiments, inked microscope slide 20 may be manufactured by providing a microscope slide 33 and applying laser-markable ink 26 to at least a portion of the surface of microscope slide 33 to create a layer of laser-markable ink 26 on microscope slide 33. In some embodiments, microscope slide 33 comprises any combination of glass, float glass, drawn glass, quartz, silica glass, acrylic glass, tempered glass, and plastic, as well as any other suitable materials and constituents thereof. In some embodiments, microscope slide 33 may be separated from sheet 14 or may be an individual slide. In some embodiments, microscope slide 33 may be sheet 14 as described herein. Further, in some embodiments, inked microscope slide 20 may be inked sheet 24 as described herein. In some embodiments, the process used to apply the layer of laser-markable ink 26 comprises any combination of screen printing, rotary screen printing, ink-jet printing, digital printing, offset printing, pad printing, gravure printing, rotogravure printing, lithograph printing, surface printing, flexographic printing, stamping, painting, drawing, sketching, and spraying, as well as any other suitable applying process and combination of constituents thereof as described above.

In some embodiments, the layer of laser-markable ink 26 may comprise any combination of an inked tab 28, an inked label 30, and an inked pattern 32, as well as any other suitable configuration of an ink layer and constituents thereof as described above. In some embodiments, inked tab 28 covers at least one edge of microscope slide 33. Further, in some embodiments, inked tab 28 extends from at least one edge of microscope slide 33 such that microscope slide 33 comprises a tab of which a user is able to hold microscope slide 33 without smudging, dirtying, and/or disrupting the surface of microscope slide 33 without the layer of laser-markable ink 26.

In some embodiments, inked label 30 comprises any combination of text, characters, and numerals, as well as any other suitable labels and constituents thereof. For example, as depicted in FIG. 3, inked label 30 may comprise a combination of characters and numerals such that inked microscope slide 20 may be distinguishable from other inked microscope slides. In another example, inked label 30 may comprise a company name and/or logo such that a plurality of identical inked microscope slides may be created. Inked label 30 and inked pattern 32 may comprise any combination of shapes, forms, bodies, patterns, fills, frames, and borders, as well as any other suitable symbol and constituents thereof. For example, inked pattern 32 may comprise a border around the edge of microscope slide 33 to indicate the usable space of microscope slide 33. Alternatively, or additionally, for example, the inked pattern 32 may comprise one or more cross shapes for indicating a suggested usable space of the microscope slide 33. Embodiments are contemplated in which inked pattern 32 comprises a shape to distinguish the utilization of inked microscope slide 20. For example, inked microscope slide 20 with inked pattern 32 comprising a circle shape may be utilized for different purposes than inked microscope slide 20 with inked pattern 32 comprising a square shape. In another example, inked pattern 32 may be utilized to indicate a corresponding coating applied to microscope slide 33, as discussed below.

FIG. 4 depicts an exemplary laser marking process 34. In some embodiments, laser marking process 34 may comprise marking at least a portion of the layer of laser-markable ink 26 on sheet 14 comprising one or more microscope slides including microscope slide 33. The laser marking process 34 described herein may be similarly applied to microscope slide 33. Further, in some embodiments, the marked portion comprises any combination of indicia 36 and/or marked label 38, as well as any other suitable markings and constituents thereof. In some embodiments, indicia 36 may comprise data for sheet 14. Further, in some embodiments, indicia 36 may comprise any of patient information, an identification number, a date, a time, text, and numerals, as well as any other suitable information and constituents thereof. For example, indicia 36 may comprise information about a patient, when a sample on a microscope slide (e.g., microscope slide 33) was taken, and an identification number for the sample on a microscope slide.

In some embodiments, indicia 36 may comprise QR code 36A, barcode 36B (e.g., a one-dimensional (1D) barcode and/or a two-dimensional (2D) barcode), and/or any other machine-readable indicia. For example, indicia 36 may comprise QR code 36A encoded with an identification number. In some embodiments, indicia 36 may comprise machine-readable media indicative of the data for one or more microscope slides (e.g., microscope slide 33) from the plurality of microscope slides that can be manufactured from sheet 14. In some embodiments, a scanner may be used to decode the information included in indicia 36. Indicia 36 may be scanned, providing a machine-readable code associated with a dataset stored in a database (e.g., Electronic Health Record (EHR)). The dataset may comprise data associated with a patient and the patient's medical history, hospital/healthcare provider information, insurance information, sample tracking information (e.g., sample, patient, date, time, hospital, insurance) and the like. As such, any data associated with the medical procedures may be documented, digitized, and stored in a database that may be accessible by scanning indicia 36 of sheet 14.

In some embodiments, marked label 38 may comprise any combination of text, characters, and numerals, as well as any other suitable labels and constituents thereof. For example, marked label 38 may comprise a combination of characters and numerals such that one or more unique identification sequences may be marked on the layer of laser-markable ink 26 of sheet 14. Embodiments are contemplated in which the marked portion may comprise any combination of shapes, forms, bodies, patterns, fills, frames, and borders, as well as any other suitable symbols and constituents thereof. In some embodiments, the marked portion may comprise at least a portion of the layer of laser-markable ink 26 and up to the entirety of the layer of laser-markable ink 26. For example, by marking QR code 36A onto the layer of laser-markable ink 26, the marked portion to create QR code 36A may comprise 40% of the layer of laser-markable ink 26. In another example, the marked portion may comprise the entirety of laser-markable ink 26 to create marked label 38.

In some embodiments, laser marking process 34 may rely on laser-markable ink 26 reacting to laser 22 to mark laser-markable ink 26. For example, laser 22 may initiate a reaction on at least a portion of laser-markable ink 26. In some embodiments, the reaction comprises any combination of oxidation, carbonization, polymerization, decomposition, foaming, cross-linking and/or other suitable reaction. For example, laser-markable ink 26 may be subjected to a carbonization reaction such that the color of laser-markable ink 26 may be darkened. Embodiments are contemplated in which the layer of laser-markable ink 26 may be a darker color, and when laser marking process 34 is applied, laser 22 initiates a reaction of at least a portion of laser-markable ink 26 to brighten the color of laser-markable ink 26. The carbonization process may convert components, particularly organic components, of laser-markable ink 26 to carbon such that a darkened color may be generated where laser-markable ink 26 has been exposed to the beam, from laser 22. Furthermore, in some embodiments, additives may be added to laser-markable ink 26 to facilitate or assist in the facilitation of the chemical reaction. For example, titanium dioxide may comprise any percentage of the overall formulation. For example, titanium dioxide may comprise approximately 1%-75% or 20%-60% of the total formulation of laser-markable ink 26.

In some embodiments, the resulting brightness of the marking may depend on the characteristics of laser-markable ink 26. In some embodiments, the brightness may depend, at least in part, on the thickness of the layer of laser-markable ink 26. For example, a marking on a thicker layer of laser-markable ink 26 may result in a darker marking than a thinner layer of laser-markable ink 26. In some embodiments, the color and/or hue of the marking may depend at least in part on the initial color of the layer of laser-markable ink 26. Furthermore, the characteristics of laser-markable ink 26 contributing to the resulting brightness may include the thickness, mixture, added coloring of laser-markable ink 26.

In some embodiments, at least one parameter may be selected for laser marking process 34 prior to providing laser marking process 34. In some embodiments, the parameters for laser marking process 34 comprise any combination of wavelength, energy density, laser marking speed, power, frequency, pulse length, spot size, and spot shape. In some embodiments, the selected parameters depend, at least in part, on the characteristics of the layer of laser-markable ink 26. Further, in some embodiments, the selected parameters depend at least in part on any combination of chemical properties, physical properties, and composition of laser-markable ink 26. The selected ink characteristics and selected laser parameters may be selected to generate one or more labeled microscope slides 40. Furthermore, in some embodiments, an extra step of separating each slide from sheet 14 may be added to the laser marking process 34 when applied to sheet 14. Embodiments are contemplated in which a plurality of lasers (e.g., laser 22) may be utilized to mark the layer on sheet 14 such that multiple portions of the layer of laser-markable ink 26 on sheet 14 are being marked simultaneously.

In some embodiments, laser marking process 34 may be applied to microscope slide 33 by marking at least a portion of the layer of laser-markable ink 26 on microscope slide 33. Further, in some embodiments, the marked portion comprises any combination of the above-described indicia 36 and/or marked label 38, as well as any other suitable markings and constituents thereof. In some embodiments, indicia 36 may comprise machine-readable media indicative of the data for microscope slide 33. Furthermore, the data may include any of a patient and the patient's medical history, hospital/healthcare provider information, insurance information, and sample tracking information (e.g., sample, patient, date, time, hospital, insurance) as described above.

FIG. 5 depicts an exemplary plurality of labeled microscope slides 40 created by laser marking process 34 described above. In some embodiments, sheet 14 may be separated to create a plurality of labeled microscope slides 40. In other embodiments, the sheet may be separated prior to labeling, and the slides labeled individually. In some embodiments, a plurality of labeled microscope slides 40 may be manufactured utilizing a curing process, a separating process, and a cleaning process. In some embodiments, the curing process comprises any combination of drying, heating, UV curing, infrared (IR) curing, and polymerizing, as well as any suitable curing process and constituents thereof. For example, the curing process may comprise convection heating. In some embodiments, the separating process comprises any combination of laser cutting, diamond wheel cutting, waterjet cutting, scribing, and breaking, using any combination of a dicing saw, a diamond tip, a knife, a glass cutter, a glass cutting machine, a scribe, mechanical force, and the like, as well as any suitable separating process, separating device, and constituents thereof. For example, the separating process may use a dicing saw. In some embodiments, the cleaning process uses any combination of a vacuum, glass cleaner, alcohol, ethanol, acetone, cleaning solution, ethyl alcohol, and soap, as well as any suitable cleaning device and constituents thereof. For example, a cleaning process may use a vacuum to clean possible particulates created during a separating process.

In some embodiments, one or more microscope slides (e.g., microscope slide 33) from the plurality of labeled microscope slides 40 may comprise any combination of inked tab 28, inked label 30, inked pattern 32, indicia 36, and marked label 38, as well as any other suitable labels and constituents thereof. For example, as depicted in FIG. 5, each microscope slide from the plurality of labeled microscope slides 40 may comprise inked tab 28, inked label 30, inked pattern 32, indicia 36, and marked label 38. In some embodiments, each labeled microscope slide from the plurality of labeled microscope slides 40 may have a different label from the rest of the plurality of labeled microscope slides 40. In some embodiments, one or more microscope slides (e.g., microscope slide 33) from the plurality of labeled microscope slides 40 are not etched. For example, markings on one or more microscope slides from the plurality of labeled microscope slides 40 may not etch through laser-markable ink 26 and in some embodiments do not comprise etchings created through a laser etching process.

In some embodiments, laser-markable ink 26 may be formulated so as to resist one or more chemical treatments to which the slide is subjected. In such embodiments, one or more labeled microscope slides 40 may endure one or more tests or treatments without damaging or altering the layer of laser-markable ink 26 and/or the marked portion of the layer of laser-markable ink 26. For example, one or more labeled microscope slides 40 may endure any combination of stains, counter stains, chemical baths, temperature fluctuations, freezes, and bakes, as well as any other suitable tests. In some embodiments, one or more labeled microscope slides 40 receive a coating to facilitate resistance to degradation and damage. Further, in some embodiments, the coating may be applied to at least a portion of the surface area of one or more labeled microscope slides 40. For example, an epoxy coating may be applied over the layer of laser-markable ink 26 on one or more labeled microscope slides 40. Embodiments are contemplated in which the coating may comprise any combination of silicone, acrylic, lacquer, urethane, epoxy, resin, alkyd, urethane, phenolic, polyester, polyethylene, polypropylene, and polytetrafluoroethylene (PTFE) based resins, as well as any other suitable coating and constituents thereof. The manufacturing processes described herein may result in one or more labeled microscope slides 40 that may remain undamaged for over 20 years and undegraded for over 15 years. In some embodiments, as glass is inert, there may be little-to-no degradation over time. As such, any coating may be unnecessary based on the material used for sheet 14.

In some embodiments, sheet 14 may be cured, separated, and cleaned to create the plurality of labeled microscope slides 40 after receiving laser marking process 34, as illustrated in FIG. 5. Alternatively, embodiments are contemplated in which the curing, separating, and cleaning may be done prior to providing laser marking process 34 to create a plurality of microscope slides, each with a layer of laser-markable ink 26 (i.e., a plurality of inked microscope slides 20). Such embodiments may provide laser marking process 34 to each inked microscope slide manufactured by the inked sheet 24. In some embodiments, the curing, separating, and cleaning may be performed in the manufacturing process by a slide manufacturer or by an end user. In some embodiments, laser marking process 34 may be configured to mark one or more inked microscope slides sequentially or concurrently. For example, the plurality of inked microscope slides may be positioned adjacent to each other such that laser marking process 34 may be provided to the plurality of inked microscope slides simultaneously.

Embodiments are contemplated in which each of the plurality of labeled microscope slides 40 comprise a coating. In some embodiments, the coating comprises any of a hydrophilicity coating, a hydrophobicity coating, a chemical adhesive, a physical adhesive, and an electrostatic adhesive, as well as any other suitable coating and constituents thereof. In some embodiments, the coating is applied to the plurality of labeled microscope slides 40. Alternatively, the coating may be applied prior to receiving laser marking process 34. For example, a coating may be applied to a plurality of inked microscope slides (e.g., a plurality of inked microscope slides 20). In some embodiments, the coating may be utilized to adhere a sample to a microscope slide.

FIG. 6 depicts an exemplary method 600 for manufacturing laser-markable ink 26. In some embodiments, all, or some of the steps of the methods described herein may be performed by an ink manufacturer for producing slides for an end user. Similarly, or alternatively, laser-markable ink 26, laser parameters, and process descriptions, may be provided to the end user (e.g., a lab, a hospital, an education institution, a pharmaceutical company, or the like), and the end user may perform all or some of the methods described herein. At step 602, dye or pigmented ink, polymer additives, inorganic materials, and solvent may be mixed to create laser-markable ink 26. In some embodiments, mixing may be achieved by utilizing any combination of a vortex mixer, a paddle mixer, a tumbler mixer, a blender, a stand mixer, a static mixer, an agitator, a roller mill, and a homogenizer, as well as any other suitable mixing devices and any constituents thereof. In some embodiments, the mixture may comprise, by weight percent, 24% to 99% dye or pigmented ink, 1% to 75% inorganic material, 1% to 40% polymer additives, and 0% to 50% solvent. For example, the mixture may comprise, by weight percent, 55% pigmented ink, 25% inorganic material, 15% polymer additive, and 5% solvent. In another example, the mixture may comprise, by weight percent, 55% pigmented ink, 30% inorganic material, 10% polymer additive, and 5% solvent. Broadly, any suitable ink formulation is contemplated for use with the invention.

In some embodiments, the polymer additives comprise any combination of polymethyl methacrylate (PMMA), cellulose acetate butyrate (CAB), cellulose acetate propionate (CAP), poly(2,6-dimethyl-1,4-phenylene oxide) (PPO), poly(1,4-phenylene sulfide) (PPS), polyethylene (PE), polyethylene glycol (PEG), polyvinyl alcohol (PVA), polyether ether ketone (PEEK), polyamide, nylon, nylon 6, polypropylene (PP), polystyrene (PS), polyurethane, polyvinyl chloride (PVC), silicone, polyester, polyethylene terephthalate (PET), as well as any other suitable polymer additive and constituents thereof. In some embodiments, the inorganic material comprises any combination of such as bismuth (III) oxide, antimony (III) oxide, antimony tin oxide, titanium (IV) oxide, aluminum oxide, aluminum silicate, titanium carbide, indium tin oxide, yttrium aluminum oxide, and titanium dioxide, as well as any other suitable inorganic material and constituents thereof. In some embodiments, the solvent may comprise any combination of water, acetone, alcohols, ethers, and aromatic hydrocarbons, as well as any other suitable solvent and constituents thereof. Embodiments are contemplated in which dye may be used in tandem or instead of pigmented ink.

In some embodiments, the mixture formulation may depend, at least in part, on the desired color of the pigmented ink. Alternatively, in some embodiments, a formulation of the mixture may be utilized regardless of the color of the pigmented ink. In some embodiments, the pigmented ink may comprise any combination of white, black, blue, green, red, cyan, magenta, and yellow, as well as any other suitable color and constituents thereof. For example, a mixture of red pigmented ink and blue pigmented ink may provide a pigmented ink with a purple coloring. Embodiments are contemplated in which laser-markable ink 26 may be transparent, translucent, or opaque prior to marking. In some embodiments, white pigmented ink and/or black pigmented ink may be added to other colored pigmented ink to create different hues, tints, tones, or shades of another pigmented ink. In some embodiments, the viscosity of the ink may be within a range of 0.01 kilo-centipoise (KcPs) to 1,000 KcPs. The exemplary ranges provided herein may be preferred, in embodiments; however, inks can exist and be processed at lower and higher viscosities depending on methods. For example, digital printing inks may comprise 10 centipoise (0.01 kilo-centipoise). Furthermore, an appropriate range could be 30 kilo-centipoise to 100 kilo-centipoise for various printing methods. Any method described herein may be optimized based on laser parameters, ink type, sheet material type, process type, and the like. In some embodiments, heating or cooling may be applied sequentially and/or concurrently with the manufacturing of the laser-markable ink 26. For example, heating may be applied to facilitate the mixing of the pigmented ink, polymer additives, inorganic materials, and solvent.

At step 604, the ink mixture from step 602 may be rested. In some embodiments, resting the ink mixture comprises letting the mixture set overnight. In some embodiments, resting the ink mixture comprises letting the ink mixture set for 4 or more hours. Alternatively, or additionally, in some embodiments, resting the ink mixture additionally comprises heating the ink mixture. In such embodiments, heating the ink mixture may improve the quality of the mixture, such as removing any air bubbles or impurities within the mixture. In some embodiments, resting the ink mixture may allow laser-markable ink 26 to reach a predetermined viscosity before being applied to microscope slide 33. Embodiments are contemplated in which step 604 may be optional such that laser-markable ink 26 may be used directly after manufacturing the mixture.

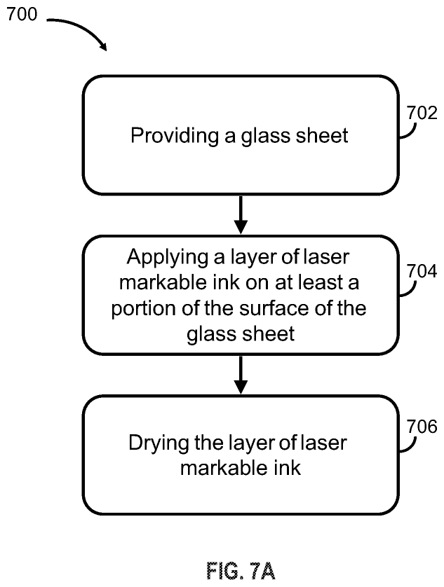

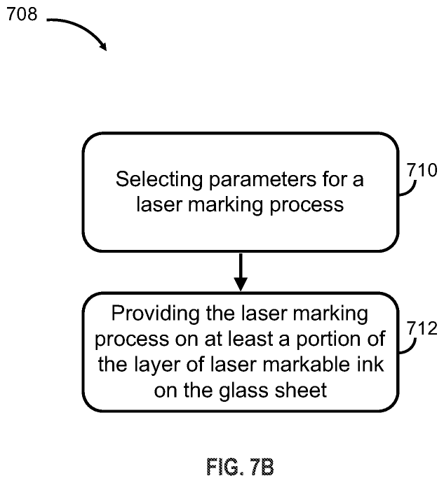

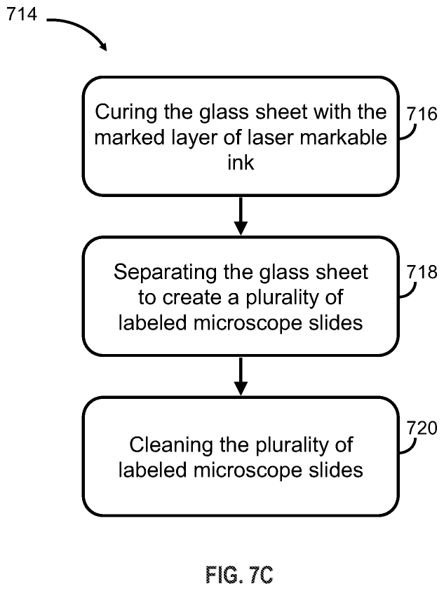

FIGS. 7A-7C depict an exemplary method for creating one or more labeled microscope slides 40, wherein FIG. 7A depicts an exemplary method 700 for applying a layer of laser-markable ink 26 to a sheet 14, FIG. 7B depicts an exemplary method 708 for providing a laser marking process 34 to a sheet 14 with the layer of laser-markable ink 26, and FIG. 7C depicts an exemplary method 714 for creating one or more labeled microscope slides 40 from sheet 14. Combined, the methods shown in FIGS. 7A-7C illustrate a method for creating one or more labeled microscope slides 40. However, FIG. 7A, FIG. 7B, and FIG. 7C may be viewed separately.

FIG. 7A depicts an exemplary method 700 for applying a layer of laser-markable ink 26 to a sheet 14. At step 702, a sheet 14 may be provided. Embodiments are contemplated in which sheet 14 may be provided by another entity at step 702. Embodiments are contemplated in which sheet 14 may comprise any material suitable for manufacturing microscope slides. For example, sheet 14 may be composed of glass and/or plastic. Embodiments are contemplated in which microscope slide 33 may be sheet 14 as described in FIGS. 7A-7C.

At step 704, a layer of laser-markable ink 26 may be applied to at least a portion of the surface of sheet 14. In some embodiments, the process used to apply the layer of laser-markable ink 26 comprises any combination of a screen-printing process, a rotary screen printing process, an ink-jet printing process, a digital printing process, an offset printing process, a pad printing process, a gravure printing process, a rotogravure printing process, a lithograph printing process, a surface printing process, a flexographic printing process, a stamping process, a painting process, a drawing process, a sketching process, and a spraying process, as well as any other suitable applying process and constituents thereof. In some embodiments, more than one layer of laser-markable ink 26 may be applied to sheet 14. For example, a first layer of laser-markable ink 26 with a first color may be provided on a first portion of the surface of sheet 14 and a second layer of laser-markable ink 26 with a second color may be provided on a second portion of the surface of sheet 14. In some embodiments, a first portion covered by a first layer of laser-markable ink 26, and a second portion covered by a second layer of laser-markable ink 26 may at least partially overlap. Alternatively, in some embodiments, a portion covered by a first layer of laser-markable ink 26, and a portion covered by a second layer of laser-markable ink 26 may be disjoint locations such that the first layer and the second layer do not overlap. In some embodiments, one or more layers of laser-markable ink 26 may be sequentially or concurrently applied to sheet 14. For example, in a screen-printing process, a first layer comprising a first color and a second layer comprising a second color of laser-markable ink 26 may be applied sequentially using a conveyor belt system incorporated into the screen-printing process. Embodiments are contemplated in which one or more inks may be applied with at least one layer of laser-markable ink 26. Further, one or more inks may comprise any combination of non-laser markable ink and/or laser-markable ink 26, as well as any other suitable ink and constituents thereof.

At step 706, the layer of laser-markable ink 26 may be dried. This ensures laser-markable ink 26 is no longer transferrable to other objects or surfaces through touch or by dripping excess laser-markable ink 26 from the surface of sheet 14. In some embodiments, the drying may comprise any combination of heated drying, air drying, solar drying, UV drying, IR drying, and dielectric drying, as well as any other suitable drying method and constituents thereof.

FIG. 7B depicts an exemplary method 708 for providing a laser marking process 34 to a sheet 14 with the layer of laser-markable ink 26. At step 710, at least one parameter for a laser marking process 34 may be selected. In some embodiments, parameters for laser-marking process 34 include wavelength, energy density, laser marking speed, power, frequency, pulse length, spot size, and spot shape, as well as any other suitable parameter and constituents thereof. In some embodiments, the wavelength of laser 22 may be within a range of 157 nm to 10,600 nm. Further, in some embodiments, the wavelength of laser 22 may be within a range of 500 nm to 5,000 nm. For example, the wavelength of laser 22 may have a wavelength of 1064 nm. Furthermore, the wavelength of laser 22 may be in the ultraviolet (UV) range of 300 nm to 400 nm. Any wavelength range that provides a benefit may be utilized for laser 22. In some embodiments, the energy density of laser 22 may be within a range of 0.3 mJ/cm² to 50 mJ/cm². In some embodiments, the laser marking speed of laser 22 may be within a range of 100 mm/s to 2,000 mm/s. Further, in some embodiments, the laser marking speed of laser 22 may be within a range of 600 mm/s to 1200 mm/s. For example, the laser marking speed of laser 22 may be 1,000 mm/s.

In some embodiments, the power of laser 22 may be within a range of 5% to 100% of the total power of laser 22. Further, in some embodiments, the power of laser 22 may be within a range of 50% to 100% of the total power of laser 22. Embodiments are contemplated in which the total power of laser 22 may be within a range of 1 W to 1,000 W. For example, the total power of laser 22 is 100 W.

In some embodiments, the frequency of laser 22 may be within a range of 5 KHz to 500 KHz. For example, the frequency of laser 22 may be 300 kHz. Further, in some embodiments, the frequency of laser 22 may be within a range of 50 kHz to 200 kHz. In some embodiments, the pulse length of laser 22 may be within the range of 5 μs to 50 μs. Further, in some embodiments, the pulse length of laser 22 may be within the range of 10 μs to 25 μs. For example, the pulse length of laser 22 may be 20 μs.

In some embodiments, the selected parameters depend at least in part on the type of laser used for laser marking process 34. In some embodiments, the selected parameters depend, at least in part, on the layer of laser-markable ink 26. Further, in some embodiments, the selected parameters depend, at least in part, on any combination of chemical properties, physical properties, and composition of laser-markable ink 26. For example, in some embodiments, laser parameters may comprise both non-visible laser parameters (e.g., wavelength 1064 nm, maximum power output 3 W, minimum pulse energy 0.1 mJ, and pulse duration 3 nanoseconds), and visible laser parameters (e.g., wavelength 640 nm and maximum output power of 5 milliwatts). The parameters of laser 22 described herein are intended to be exemplary only and may be modified to optimize marking of laser-markable ink 26 on sheet 14.

At step 712, laser marking process 34 may be provided to at least a portion of the layer of ink on the sheet. In some embodiments, laser marking process 34 may label sheet 14 by marking at least a portion of the layer of laser-markable ink 26. Further, in some embodiments, the marked portion comprises any combination of indicia 36 and/or marked label 38, as well as any other suitable markings and constituents thereof. In some embodiments, indicia 36 may comprise data for one or more microscope slides from the plurality of microscope slides that may be manufactured by sheet 14. Further, in some embodiments, indicia 36 may comprise any of patient information, an identification number, a date, a time, text, and numerals, as well as any other suitable information and constituents thereof. For example, indicia 36 may comprise information about a patient, when a sample was taken, and an identification number. In some embodiments, indicia 36 may comprise QR code 36A, barcode 36B (e.g., a 1D barcode and/or a 2D barcode), and/or any other machine-readable indicia. In some embodiments, marked label 38 may comprise any combination of text, characters, and numerals, as well as any other suitable labels and constituents thereof. For example, marked label 38 may comprise a combination of characters and numerals such that a unique identification sequence is marked on the layer of sheet 14. Embodiments are contemplated in which a plurality of lasers may be utilized to mark the layer on sheet 14 such that multiple portions of the layer are marked simultaneously.

In some embodiments, a scanner may be used to decode the information included in indicia 36. Indicia 36 may be scanned, providing a machine-readable code associated with a dataset stored in a database (e.g., Electronic Health Record (EHR)). The dataset may comprise data associated with a patient and the patient's medical history, hospital/healthcare provider information, insurance information, sample tracking information (e.g., sample, patient, date, time, hospital, insurance) and the like. As such, any data associated with the medical procedures may be documented, digitized, and stored in a database that may be accessible by scanning indicia 36 of one or more microscope slides from the plurality of microscope slides that may be manufactured by sheet 14.

In some embodiments, laser 22 does not etch through the layer of laser-markable ink 26. For example, laser marking process 34 may rely on laser-markable ink 26 reacting to laser 22 to mark laser-markable ink 26. For example, laser 22 may initiate a reaction on at least a portion of laser-markable ink 26. In some embodiments, the reaction comprises any combination of oxidation, carbonization, polymerization, decomposition, foaming, particle migration, de-encapsulation, and cross-linking, as well as any other suitable reaction. For example, laser-markable ink 26 may be subjected to a carbonization reaction such that the color of laser-markable ink 26 may be darkened. Embodiments are contemplated in which the layer of laser-markable ink 26 may be a darker color (e.g., black or gray). As such, when laser marking process 34 is applied, laser 22 may initiate a reaction of at least a portion of laser-markable ink 26 to brighten or further darken the color of laser-markable ink 26. In some embodiments, the brightness of the marking may depend, at least in part, on the thickness of the layer of laser-markable ink 26 as well as the ink characteristics and the selected parameters of the laser. For example, a marking on a thicker layer of laser-markable ink 26 may result in a darker marking than a thinner layer of laser-markable ink 26. In some embodiments, the color and/or hue of the marking may depend, at least in part, on the initial color of the layer of laser-markable ink 26.

FIG. 7C depicts an exemplary method 714 for creating one or more labeled microscope slides 40 from sheet 14. At step 716, sheet 14 with the marked layer of laser-markable ink may be cured. The curing may comprise any curing technique known in the art. For example, the curing may comprise any combination of drying, heating, UV treating, IR treating, and polymerizing, as well as any other suitable curing technique and constituents thereof. In some embodiments, the curing may heat the layer of laser-markable ink 26 past its glass transition temperature such that the laser-markable ink 26 is hardened.

At step 718, sheet 14 may be separated to create the plurality of labeled microscope slides 40. Step 718 may comprise any separating technique known in the art. For example, the separating may comprise any combination of laser cutting, diamond wheel cutting, waterjet cutting, scribing, and breaking, using any combination of a dicing saw, a diamond tip, a knife, a glass cutter, a glass cutting machine, a scribe, mechanical force, and the like, as well as any other suitable separating technique and constituents thereof. In some embodiments, sheet 14 may have indicators to indicate one or more locations that require separating. In some embodiments, the layer of laser-markable ink 26 may be utilized as an indicator to indicate one or more locations of sheet 14 that require separating to manufacture one or more labeled microscope slides. Embodiments are contemplated in which microscope slide 33 may be sheet 14. In such embodiments, step 718 may be optional such that microscope slide 33 is not separated.

At step 720, the plurality of labeled microscope slides 40 may be cleaned. The cleaning may comprise any glass cleaning technique known in the art. For example, the cleaning may use any combination of a vacuum, glass cleaner, alcohol, ethanol, acetone, cleaning solution, and ethyl alcohol, as well as any other suitable glass cleaning device and constituents thereof. In some embodiments, step 720 removes particulates created through the separating during step 718. For example, glass fibers and/or shards may accumulate on the surface of sheet 14 during step 718.

Embodiments are contemplated in which method 714 may be provided prior to method 708. Such embodiments may manufacture a plurality of inked microscope slides (e.g., inked microscope slide 20) and then provide laser marking process 34 to each inked microscope slide manufactured by inked sheet 24. In some embodiments, laser marking process 34 may be configured to mark one or more inked microscope slides sequentially or concurrently. For example, the plurality of inked microscope slides may be positioned adjacent to each other such that laser marking process 34 may be provided to the plurality of inked microscope slides simultaneously. In some embodiments, providing laser marking process 34 to each inked microscope slide 20 creates a plurality of labeled microscope slides 40. Embodiments are contemplated in which method 708 and/or method 714 may be performed in the manufacturing process by a slide manufacturer or by an end user.

In some embodiments, sheet 14 may be placed on platform 16 for any of the above steps. Further, in some embodiments, the above steps may be performed in an automated process, a manual process, or a combination of manual and automated. In some embodiments, the automated process may comprise automatically retrieving, tabbing, marking, and packaging sheet 14. Similarly, a plurality of sheets may be retrieved, tabbed, marked, and packaged. As such, sheet 14, in some embodiments, sheet 14 may represent at least one slide, one or more slides, and/or a plurality of slides. For example, sheet 14 may comprise a plurality of slides or a single slide (e.g., slide 20). As such, the processes described herein may apply to sheet 14 comprising a plurality of slides or sheet 14 comprising a single slide (e.g., inked slide 20 or slide 33).

FIG. 8 depicts one example of a hardware platform representative of an embodiment of hardware system 800 that may comprise laser marking system 10 in the embodiments described above. Computer 802 can be any form factor of general- or special-purpose computing device. Depicted with computer 802 are several components, for illustrative purposes. In some embodiments, certain components may be arranged differently or absent. Additional components may also be present. Included in computer 802 is system bus 804, whereby other components of computer 802 can communicate with each other. In certain embodiments, there may be multiple buses or components may communicate with each other directly. Connected to system bus 804 is central processing unit (CPU) 806. Also attached to system bus 804 are one or more random-access memory (RAM) modules 808. Also attached to system bus 804 is graphics card 810. In some embodiments, graphics card 810 may not be a physically separate card but rather may be integrated into the motherboard or the CPU 806. In some embodiments, graphics card 810 has a separate graphics processing unit (GPU) 812, which can be used for graphics processing or for general-purpose computing (GPGPU). Also on graphics card 810 is GPU memory 814. Connected (directly or indirectly) to graphics card 810 is display 816 for user interaction. In some embodiments, no display is present, while in others, it is integrated into computer 802. Similarly, peripherals such as keyboard 818 and mouse 820 are connected to system bus 804. Like display 816, these peripherals may be integrated into computer 802 or absent and may be provided as inputs by display 816. Also connected to system bus 804 is local storage 822, which may be any form of computer-readable media and may be internally installed in computer 802 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store non-transitory data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations. In particular, computer-readable media includes non-transitory computer-readable media storing computer-executable instructions that, when executed, cause one or more processors to carry out operations.

Finally, network interface card (NIC) 824 is also attached to system bus 804 and allows computer 802 to communicate over a network such as local network 826. NIC 824 can be any form of network interface known in the art, such as Ethernet, ATM, fiber, Bluetooth, or Wi-Fi (i.e., the IEEE 802.11 family of standards). NIC 824 connects computer 802 to local network 826, which may also include one or more other computers, such as computer 828, and network storage, such as data store 830. Generally, a data store such as data store 830 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write, and seek operations, or any level of complexity in between. Some data stores may additionally provide management functions for data sets stored therein, such as backup or versioning. Data stores can be local to a single computer, such as computer 828, accessible on a local network, such as local network 826, or remotely accessible over Internet 832. Local network 826 is, in turn, connected to Internet 832, which connects many networks such as local network 826, remote network 834, or directly attached computers such as computer 836. In some embodiments, computer 802 can itself be directly connected to Internet 832.

Although the present disclosure has been described with reference to the embodiments illustrated in the attached drawing figures, it is noted that equivalents may be employed, and substitutions made herein without departing from the scope of the present disclosure as recited in the claims.

Having thus described various embodiments of the present disclosure, what is claimed as new and desired to be protected by Letters Patent includes the following:

1. A method for labeling a microscope slide, the method comprising:
applying laser-markable ink to at least a portion of the microscope slide; and
exposing a patterned portion of the laser-markable ink on the microscope slide to a laser beam,
thereby initiating a chemical reaction in the laser-markable ink to cause a change in color in the patterned portion of the laser-markable ink without etching a surface of the microscope slide.

2. The method of claim 1, further comprising:
selecting a value for a parameter for the laser beam,
wherein the parameter is selected from a set consisting of a wavelength, an energy density, a laser speed, a power, a frequency, a pulse length, a spot size, and a spot shape.

3. The method of claim 1, wherein the laser-markable ink is applied in a thickness range of 5 micrometers to 200 micrometers.

4. The method of claim 1, wherein the chemical reaction comprises a carbonization of the laser-markable ink.

5. The method of claim 1, wherein the laser-markable ink comprises a dye or a pigmented ink, a polymer additive, an inorganic material, and a solvent.

6. The method of claim 5, wherein the portion of the microscope slide is selected from a set consisting of a tab, a label, and a pattern.

7. The method of claim 1, wherein the patterned portion of the laser-markable ink is selected from a set consisting of a quick response code, a one-dimensional barcode, a two-dimensional barcode, and a text label.

8. A method for manufacturing a plurality of labeled microscope slides, the method comprising:
providing a sheet of slide material comprising a laser-markable ink on at least a portion of the sheet of the slide material; and
exposing a patterned portion of the laser-markable ink on the sheet of the slide material to a laser beam,
thereby initiating a chemical reaction in the laser-markable ink to cause a change in color in the patterned portion of the laser-markable ink without etching a surface of the sheet of the slide material; and
separating the sheet of the slide material into the plurality of labeled microscope slides.

9. The method of claim 8, wherein the laser-markable ink is applied in a thickness range of 5 micrometers to 200 micrometers.

10. The method of claim 9, wherein the laser-markable ink is a first laser-markable ink of a first color, further comprising:
applying a second laser-markable ink of a second color to at least another portion of the sheet of the slide material.

11. The method of claim 8,
selecting a value for a parameter for the laser beam,
wherein the parameter is selected from a set consisting of a wavelength, an energy density, a laser speed, a power, a frequency, a pulse length, a spot size, and spot shape.

12. The method of claim 8, wherein the chemical reaction comprises a carbonization reaction.

13. The method of claim 12, wherein the chemical reaction changes a brightness of the color of the patterned portion of the laser-markable ink and wherein the patterned portion is selected from a set consisting of a quick response code, a one-dimensional barcode, a two-dimensional barcode, and a marked label.

14. The method of claim 8, further comprising heating the laser-markable ink prior to exposing the laser-markable ink to the laser beam.

15. A method for manufacturing labeled microscope slides, the method comprising:
providing a sheet of slide material comprising a laser-markable ink on the sheet of the slide material;
separating the sheet of the slide material into a plurality of slides,
wherein the laser-markable ink covers a portion of each of the plurality of slides; and
exposing a patterned portion of the laser-markable ink on a microscope slide of the plurality of slides to a laser beam,
thereby initiating a chemical reaction in the laser-markable ink to cause a change in color in the patterned portion without etching a surface of the microscope slide.

16. The method of claim 15, wherein the sheet of the slide material comprises one or more inks on at least another portion of the sheet of the slide material.

17. The method of claim 15, wherein the sheet of the slide material comprises a coating on the sheet of the slide material.

18. The method of claim 15, wherein the chemical reaction comprises carbonization of an organic component of the laser-markable ink.

19. The method of claim 18, wherein the chemical reaction changes a brightness of the color of the laser-markable ink to create a marked portion corresponding to the patterned portion.

20. The method of claim 19, wherein the marked portion is selected from a set consisting of a quick response code, a one-dimensional barcode, a two-dimensional barcode, and a marked label.
